(19) United States
(12) Patent Application Publication
(10) Pub. No.: US 2013/0070587 A1
(43) Pub. Date: Mar. 21, 2013

(54) System and Method for Reducing Network Congestion Related to a Mass Notification System

(71) Applicant: Jeremy Keith Mattern, Houston, TX (US)

(72) Inventor: Jeremy Keith Mattern, Houston, TX (US)

(21) Appl. No.: 13/235,749

(22) Filed: Sep. 19, 2011

(51) Int. Cl. H04L 12/26

(52) U.S. Cl. 370/229

(57) ABSTRACT

A system and method for reducing network congestion related to a mass notification is described herein. Specifically, mass notification system can comprise a memory that stores an application, a predetermined threshold, and a plurality of contacts that comprise location data. The mass notification system can further comprise a processor that, at the direction of said application, delivers said one or more messages to a first portion of said contacts comprising a common location data at a rate, determines a delivery success rate for said first portion of said contacts, compares said deliver success rate to said predetermined threshold, adjusts said rate, and delivers said one or more messages to a second portion of said contacts at said adjusted rate.

### BACKGROUND

This disclosure relates to a system and method for reducing network congestion related to a mass notification system.

A mass notification system sends messages to people related to an event, such as a man- made emergency and/or a weather related event. The objective of a mass notification system is to notify a set of users in the shortest amount of time. Mass notification systems can notify users over a variety of networks. Typical networks include phone networks for phone and text messages, and data networks for emails. Each network can comprise any number of smaller sub-networks, often defined by such things as locality or user groups. Often, network capacity varies with each sub-network, and is dependent on sub-network architecture. Generally, sub-network architecture is designed around projected sub-network resource demand. However, sub-networks are often not designed with sufficient capacity to handle spikes in sub-network resource demand related to mass notification. As such, resource demands are large, irregular, and infrequent. Further, when mass notifications systems create a spike, sub-network resource demand often exceeds capacity. When this occurs, network resources become depleted for other users, and transmissions to and from other users of the sub-network, and to and from the mass notification system, fail.

Therefore, it would be useful and advantageous to have an improved system and method for reducing network transmission failures related to mass notifications.

### SUMMARY

A system and method for reducing network congestion related to a mass notification is described herein.

In one embodiment, mass notification system can comprise a memory that stores an application, a predetermined threshold, and a plurality of contacts that comprise location data. The mass notification system can further comprise a processor that, at the direction of said application, delivers said one or more messages to a first portion of said contacts comprising a common location data at a rate, determines a delivery success rate for said first portion of said contacts, compares said deliver success rate to said predetermined threshold, adjusts said rate, and delivers said one or more messages to a second portion of said contacts at said adjusted rate.

Additionally, a mass notification method is disclosed. The method can comprise delivering over a network a one or more messages to a first portion of contacts comprising a common location data at a rate. The method can further comprise determining a delivery success rate for said one or more messages to said first portion of said contacts, and comparing said deliver success rate to said predetermined threshold. The method can also comprise adjusting said rate, and delivering said one or more messages to a second portion of said contacts at said adjusted rate.

Finally, in one embodiment, the mass notification system can comprise a computer readable storage medium having a computer readable program code embodied therein, wherein the computer readable program code is adapted to be executed to implement the above mentioned mass notification method.

### BRIEF DESCRIPTION OF THE DRAWINGS

FIG. 1 illustrates a communication network linking a plurality of communication devices.

FIG. 2 illustrates hardware of mass notification system.

FIG. 3 illustrates a memory comprising a mass notification application, one or more contact records, messages, and a threshold.

FIG. 4 illustrates a contact record.

FIG. 5A illustrates a flow diagram showing a decrease in rate of messages.

FIG. 5B illustrates a flow diagram showing an increase in rate of messages.

### DETAILED DESCRIPTION

Described herein is a system and method for broadcasting messages and for reducing failure rates of an infrastructure. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

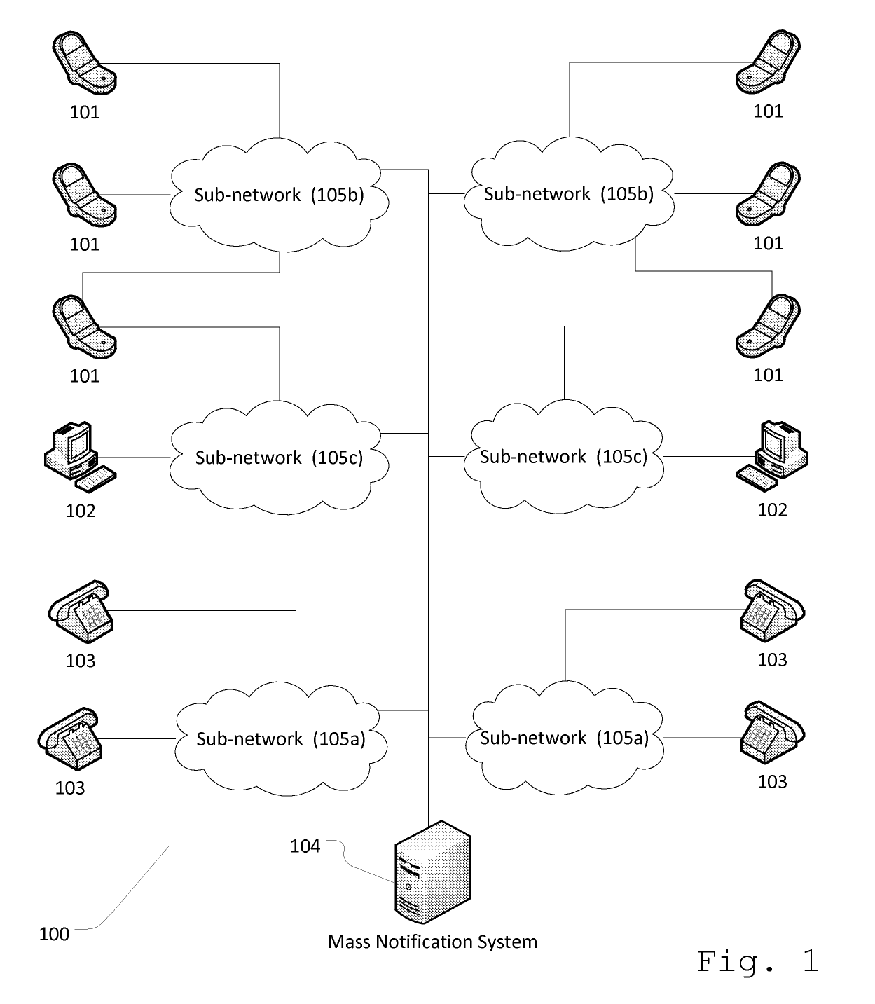

FIG. 1 illustrates a communication network 100 linking a plurality of communication devices. A communication device can include, but is not limited to, a mobile phone 101, a computer 102, a landline telephone 103, a personal digital assistant (“PDA”), or a tablet, and a mass notification system 104. Communication network 100 can comprise one or more sub-networks 105, each all or a portion of a local area network (“LAN”), a wide area network (“WAN”), a landline telephone network 105a, a cellular network 105b, a data network 105c, or any combination of the above. Sub-network 105 can be hard-wired, wireless, or a combination of both.

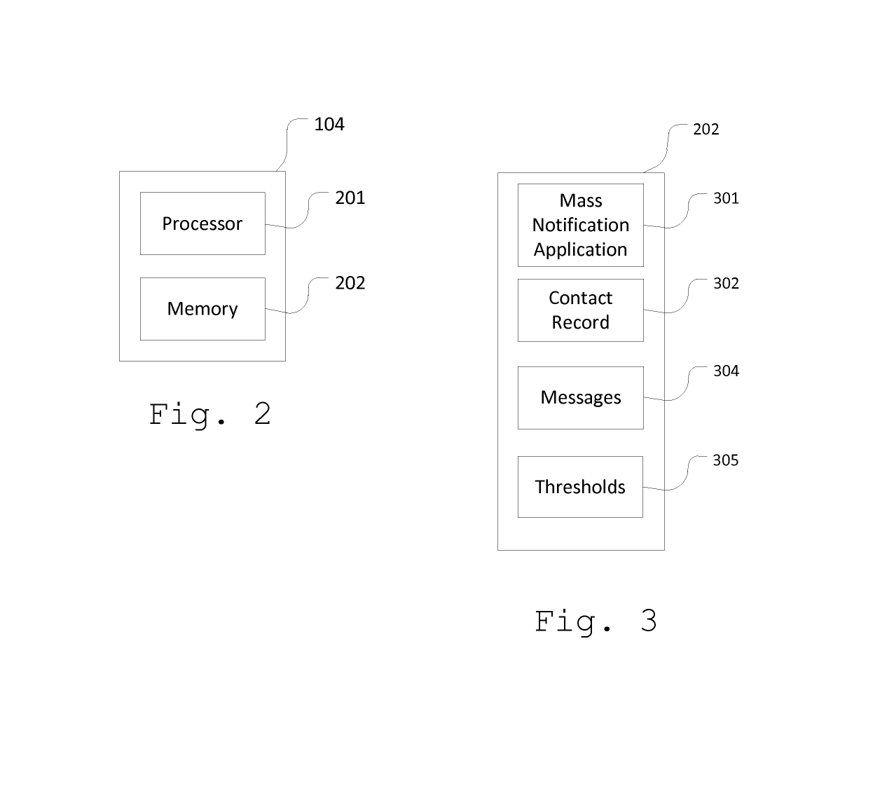

FIG. 2 illustrates hardware of mass notification system 104. Mass notification system 104 can comprise a processor 201, and a memory 202. Processor 201 can perform instructions within memory 202. Mass notification system 104 can be a server wherein processor 201 and memory 202 both reside, or exist separately from server. In other embodiments, memory 202 can be combinations of server-based memory, direct connect memory, network based memory, or in any other configuration known in the art.

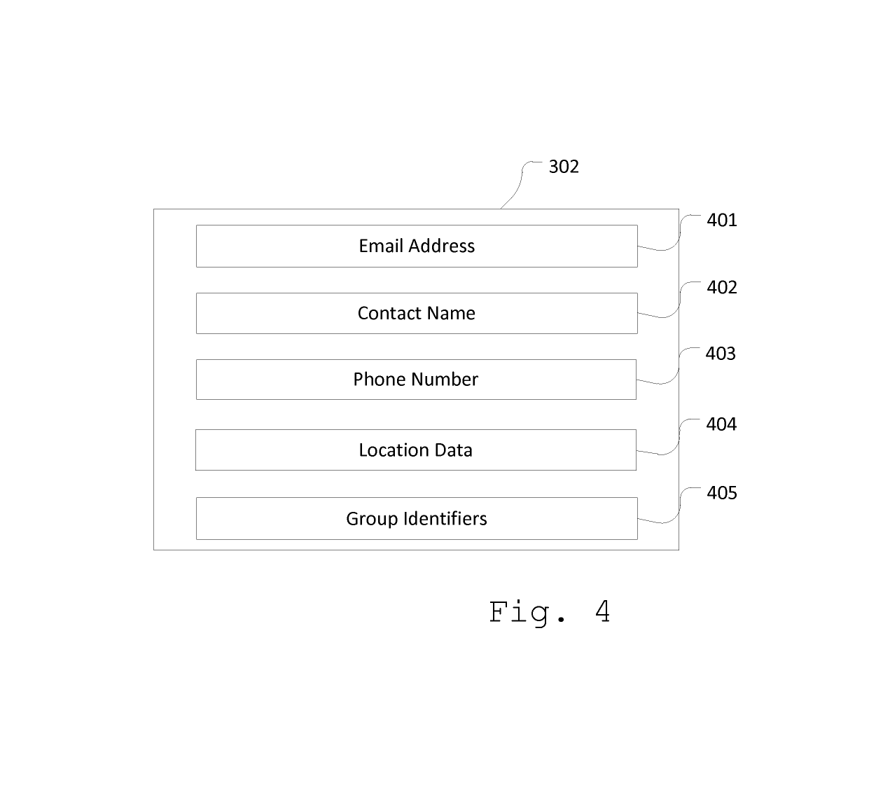

FIG. 3 illustrates a memory 202 comprising a mass notification application 301, one or more contact records 302, messages 304, and a threshold 305. Mass notification application 301 can reside and execute within memory 202, can create, delete and modify contact records 302. Furthermore, mass notification application 301 is capable of broadcasting messages 304 across communication network 100 to other communication devices at various sub-networks using a single channel or multiple channels. Messages 304 can be a phone call, pre-recorded audio message, a live audio message, and/or a text and/or image message such as Electronic Mail (“EMAIL”) and/or Short Message Service text (“SMS”). Thresholds 305 can comprise one or more specific percentages related to delivery failure and delivery success. Threshold 305 can be predefined in one embodiment, and can be adjustable by a user of mass notification system 104 or, in one embodiment, adjustable by mass notification system 104.

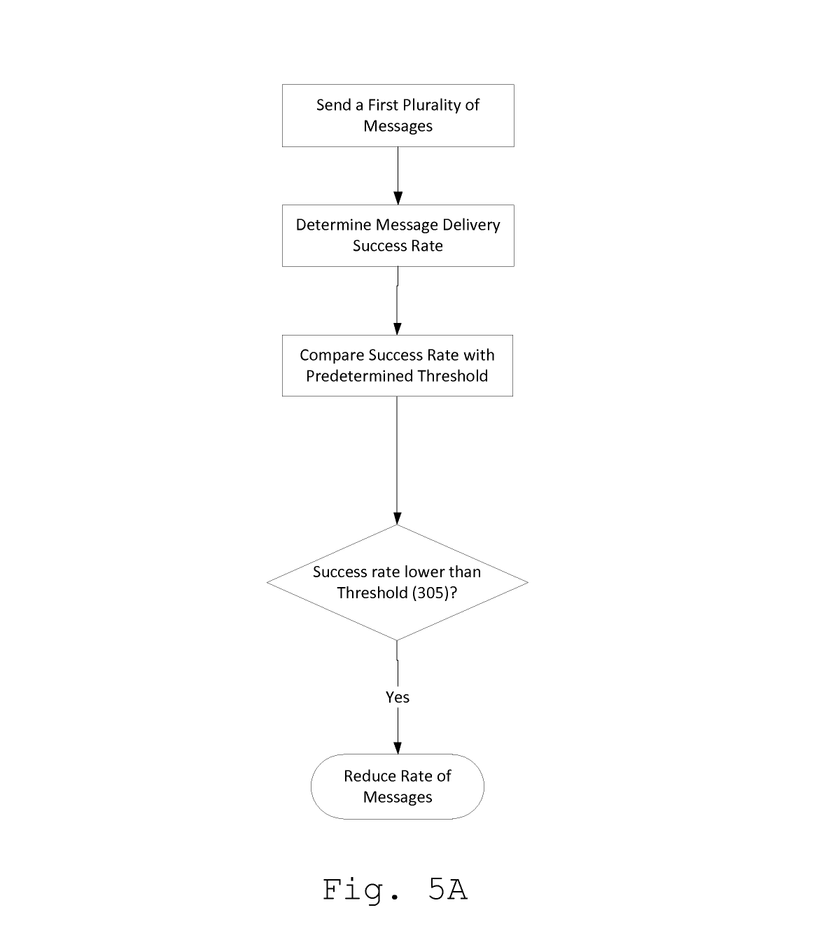

FIG. 4 illustrates a contact record 302. Each contact record 302 can include, but is not limited to, a contact name 402 a contact phone number 403, an email address 401, a location data 404 and one or one or more group identifiers 405. Using contact record 302, mass notification application 301 can send messages 304 to selected individuals within contact record 302. In one embodiment, mass notification system 104 can send a message to a group by sending a message to contacts whose contact record 302 comprises a particular group identifier. In another embodiment, memory 202 can comprise group lists. In one embodiment, group list can comprise contact name 402 contact phone number 403, and/or email address 401. Each contact can be contacted in a number of methods. Contact record 402 can also comprise a contact. For example, a preference can require a call first before email, or both simultaneously.

Location data 404 can include, but is not limited to, a building, campus, city, state, country, wider geographic area, and can be a person's work address, home address, IP address, area code, or GPS coordinates. In some embodiments, location data can include times that they are typically in that location. In another embodiment, location data can include the area code of phone number 403 or a domain of email addresses 401.

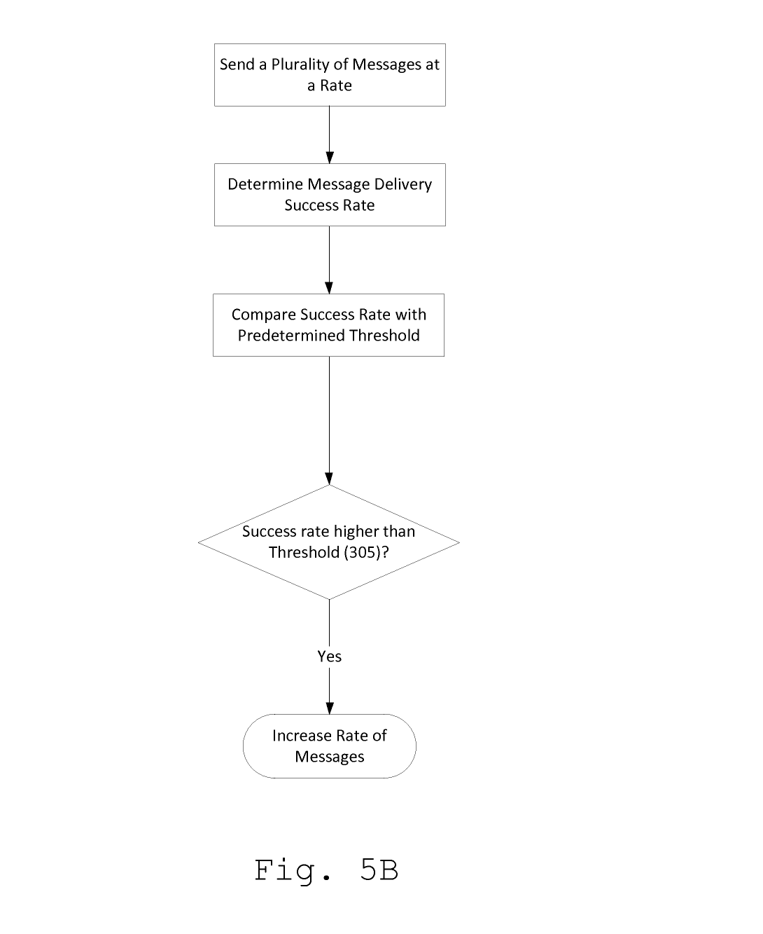

FIG. 5 illustrates exemplary flow diagrams of a mass notification system 100. FIG. 5A illustrates a flow diagram showing a decrease in rate of messages. FIG. 5B illustrates a flow diagram showing an increase in rate of messages. As an example of an embodiment, mass notification application 301 can send a message to a set of individuals across network 105. For example, mass notification system 104 can call contacts of a particular group, or all contacts, and play a recorded message. When a message is sent to a contact, the message will either be successfully sent or fail. Failure can be determined in a number of ways. For a phone call, failure can be determined, for example, by a busy signal, or an operator error message, e.g., “We're sorry but the number you are trying to reach is unavailable. Please try your call again.”. Other examples of determining a failure can be a network error code, and/or a network error message. As messages 304 are being sent, mass notification system 104 can monitor failures and determine failure rates relating to location data 404 and message protocol. Location data 404 can be important because there can be a correlation between location and common sub-network 105. As shown in FIG. 5A, if a success rate falls below a predetermined threshold 305 for a particular location, then mass notification system 104 can reduce the rate of messages over the particular message protocol to said location, to relieve sub-network 105 congestion, in one embodiment. Moreover, in between sending messages to said location, messages to other locations can be sent. As shown in FIG. 5B, if said delivery success rate is higher than said predetermined threshold 305, mass notification system 104 can increase the rate of messages over the particular message protocol to said location, in one embodiment.

Various changes in the details of the illustrated operational methods are possible without departing from the scope of the following claims. Some embodiments may combine the activities described herein as being separate steps. Similarly, one or more of the described steps may be omitted, depending upon the specific operational environment in which the method is being implemented. In addition, acts in accordance with the figures may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable storage medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain- English equivalents of the respective terms “comprising” and “wherein.”

1. A mass notification system comprising
a memory that stores
an application;
a predetermined threshold;
one or more messages; and
a plurality of contacts that comprise location data; and
a processor that, at the direction of said application,
delivers said one or more messages to a first portion of said contacts comprising common location data at a rate;
determines a delivery success rate for said first portion of said contacts;
compares said deliver success rate to said predetermined threshold;
adjusts said rate; and
delivers said one or more messages to a second portion of said contacts at said adjusted rate.

2. The mass notification system of claim 1 wherein said location data comprise an address.

3. The mass notification system of claim 1 wherein said location data comprises GPS coordinates.

4. The mass notification system of claim 1 wherein said location data comprises times when a contact associated with said contact record is in a location associated with said location record.

5. The mass notification system of claim 1 wherein to adjust said rate, processor lowers said rate if delivery success rate is below predetermined threshold.

6. The mass notification system of claim 1 wherein to adjust said rate, processor raises said rate if delivery success rate is above predetermined threshold.

7. The mass notification system of claim 1 wherein said message is transmitted over a landline telephone network.

8. The mass notification system of claim 1 wherein said message is transmitted over a cellular network.

9. The mass notification system of claim 1 wherein said message is a text message.

10. The mass notification system of claim 1 wherein said actions further comprise of reducing the rate of messages to a first location; and increasing the rate of messages to a second location.

11. A mass notification method comprising
delivering over a network a one or more messages to a first portion of contacts comprising common location data at a rate;
determining a delivery success rate for said one or more messages to said first portion of said contacts;
comparing said deliver success rate to said predetermined threshold;
adjusting said rate; and
delivering said one or more messages to a second portion of said contacts at said adjusted rate.

12. The mass notification method of claim 11 wherein determining a delivery success rate comprises
receiving one or more network error messages from a sub-network; and
comparing an amount of said one or more network error messages to an amount of said first portion of said contacts.

13. The mass notification method of claim 12 wherein said network error message is a busy signal.

14. The mass notification method of claim 12 wherein said network error message is a network error code.

15. The mass notification method of claim 12 wherein said network error message is an operator message.

16. The mass notification method of claim 12 wherein said network error message is an email.

17. The mass notification method of claim 11 wherein adjusting said rate comprises lowering said rate if delivery success rate is below predetermined threshold.

18. The mass notification method of claim 11 wherein adjusting said rate comprises raising said rate if delivery success rate is above predetermined threshold.

19. A computer readable storage medium having a computer readable program code embodied therein, wherein the computer readable program code is adapted to be executed to implement the method of claim 11.
